(19) United States
(12) Patent Application Publication
(10) Pub. No.: US 2005/0030306 A1
(43) Pub. Date: Feb. 10, 2005

(54) Video display system and method for power conservation thereof

(76) Inventors: Jet Lan, Hsin Tien City (TW); Richard Lee, Hsin Tien City (TW)

Correspondence Address: BIRCH STEWART KOLASCH & BIRCH, PO BOX 747, FALLS CHURCH, VA, 22040-0747, US

(21) Appl. No.: 10/838,344

(22) Filed: May 5, 2004

(30) Foreign Application Priority Data
Aug. 8, 2003 (TW) 92121821

(51) Int. Cl. G09G 5/00; G09G 3/36

(52) U.S. Cl. 345/211

(57) ABSTRACT

A video display system is used to display an image signal on a display unit and a method for power conservation thereof is proposed. The video display system has a CRT controller (CRTC), an image signal generator and a power controller. The CRT controller (CRTC) generates a synchronous timing signal for the display unit and a first mask signal. The image signal generator converts the image signal into a video signal with reference to the synchronous timing signal. The power controller turns off or slows down the image signal generator during an enabling time of the first mask signal, which is either a horizontal blank time or a vertical blank time.

### FIELD OF THE INVENTION

The present invention relates to a video display system and method for power conservation thereof, especially to a video display system consuming less power during video signal output.

### BACKGROUND OF THE INVENTION

Video display devices such as CRT monitors or LCD monitors are vital elements of electronic products. Therefore, a video display system for driving video display devices is of great concern to enhance the performance of video display devices and related electronic products such as computers or PDAs.

For example, current video display system can provide a power saving function for a video display device. The components of the video display system enter a speed-down mode or a power-off mode when the video display device is idle.

FIG. 1 shows a flowchart of a power saving process in a prior art video display system, which is assumed to support 2D acceleration, 3D acceleration and MPEG acceleration functions. Step 11 judges whether the 3D acceleration function has been idle for a time exceeding 100 ns. If yes, the 3D acceleration circuit is turned off or slowed down, and then the power saving process proceeds to a step 12. Otherwise, step 12 judges whether the MPEG acceleration function has been idle for a time exceeding 100 ns. If yes, the MPEG acceleration circuit is turned off, and then the power saving process proceeds to a step 13. Otherwise, step 13 judges whether the 2D acceleration function has been idle for a time exceeding 100 ns. If true the 2D acceleration circuit is turned off or slowed down. Moreover, the turning off or slowing down of the 2D/3D acceleration circuit and MPEG acceleration circuit will not influence the normal operation of the video display system when it is wakened.

The power saving process in a prior art video display system can only conserve power when the video display system is idle for a certain time in order to ensure the normal operation of the video display system.

The power saving process is especially important for the video display system in portable electronic products. However, the power saving process mentioned above cannot conserve power when the video display system of the portable electronic product is not idle.

FIG. 2 shows a scanning method of video signal output from a video display system. In the raster-scan display, the pixels are scanned from left to right, from top to bottom in a pixel-by-pixel way. The time for a scan from rightmost pixel to a leftmost pixel in next horizontal line is referred to as a horizontal blank time, and the time for a scan from rightmost pixel of bottom horizontal line to a leftmost pixel in top horizontal line is referred as a vertical blank time.

During the horizontal blank time and the vertical blank time, the video signal is not sent by the video display system. However, the video display system still consumes a certain amount of electrical power.

Therefore, the prior art video display system has a drawback in that it fails to exploit the horizontal blank time and the vertical blank time for power conservation. The power conservation ability of the prior art video display system is still not satisfactory.

### SUMMARY OF THE INVENTION

It is an object of the present invention to provide a video display system and method for power conservation thereof, which exploits the horizontal blank time and the vertical blank time for further power conservation.

To achieve the above objects, the present invention provides a video display system used to display an image signal on a display unit, comprising a CRT controller (CRTC) for generating a synchronous timing signal for the display unit and a first mask signal; an image signal generator for converting the image signal into a video signal with reference to the synchronous timing signal; and a power controller controlling a power supplied to the image signal generator with reference to the first mask signal.

To achieve the above objects, the present invention provides a method for power conservation of a video display system, in which the video display system displays an image signal on a display unit, the method comprising following steps: providing a first mask signal; and executing a power conservation operation to the video display system during an enabling time of the first mask signal.

### BRIEF DESCRIPTION OF DRAWING

The accompanying drawings, which are incorporated in and form part of the specification in which like numerals designate like parts, illustrate preferred embodiments of the present invention and, together with the description, serve to explain the principles of the invention. In the drawings:

FIG. 1 shows a flowchart of power saving process in a prior art video display system;

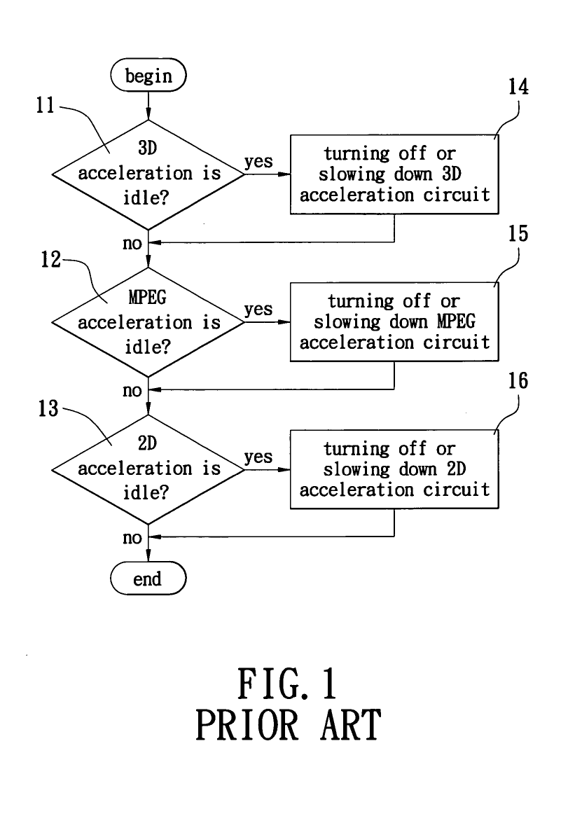

FIG. 2 shows a scanning way of video signal output from a video display system;

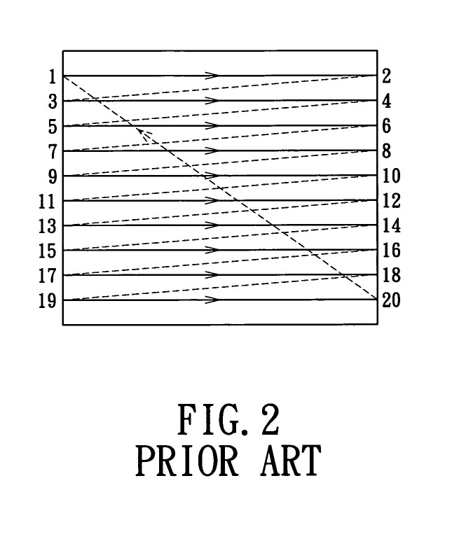

FIG. 3 shows a block diagram of the video display system according to a preferred embodiment of the present invention;

FIG. 4 shows a timing waveform of the video display system according to the preferred embodiment of the present invention; and

FIG. 5 shows a flowchart of the method for power conservation of video display system according to the preferred embodiment of the present invention.

### DETAILED DESCRIPTION OF THE INVENTION

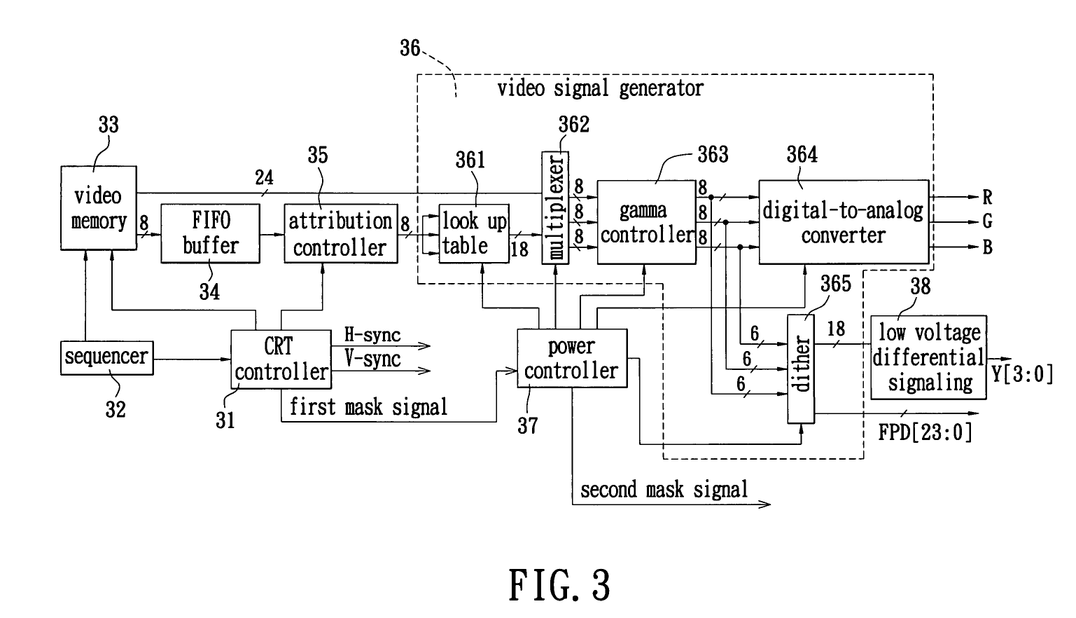

FIG. 3 shows a block diagram of the video display system according to a preferred embodiment of the present invention. The video display system according to the present invention comprises a CRT controller (CRTC) 31, a sequencer 32, an image memory 33, a FIFO buffer 34, an attribution controller 35, an image signal generator 36, a power controller 37 and a low voltage differential signaling (LVDS) 38.

The CRTC 31 controls the accessing of the image memory 33, the synchronous timing of output image and generation of a first mask signal. The first mask signal manifests the duration of the horizontal blank time and the vertical blank time and is sent to the power controller 37. The image signal generator 36 converts the image signal in the image memory 33 into a video signal with reference to the synchronous timing. In the preferred embodiment of the present invention, the image signal generator 36 comprises a look up table (LUT) 361, a multiplexer 362, a gamma controller 363, a digital-to-analog converter (DAC) 364, and a dither 365. The image signal generator 36 is conventional and not described in detail here. The image signal generator 36 can drive an analog display through the DAC 364 or drive a digital display with DVI interface through the dither 365 and the LVDS 38.

The video display system according to the present invention is characterized by the power controller 37 being provided to control the power supplied to the image signal generator 36 in order to turn off or slow down the image signal generator 36 and save power. The power controller 37 will control the power supplied to the LUT 361, the multiplexer 362, the gamma controller 363, the digital-to-analog converter (DAC) 364, and the dither 365. Since the image signal generator 36 does not provide data during the horizontal blank time and the vertical blank time, the power controller 37 will generate power control signal to turn off or slow down the image signal generator 36 when the first mask signal is enabled. Moreover, the power controller 37 will generate a power control signal to turn on or speed up the image signal generator 36 when the first mask signal is disabled. The first mask signal manifests the duration of the horizontal blank time and the vertical blank time. The image signal generator 36 converts the image signal in the image memory 33 into a video signal with reference to the synchronous timing. Moreover, the power controller 37 also generates a second mask signal to the display upon receiving the first mask signal; the second mask signal is used to mask the image during the output of the video signal.

The sequencer 32 in FIG. 3 provides sequential control signal to each building block of the image signal generator 36. The attribution controller 35 controls the attribution of image signal read in the image memory 33 and stored in the FIFO buffer 34. The attribution of image signal includes background color, flashing method and brightness, whereby the image signal generator 36 can produce a desired image.

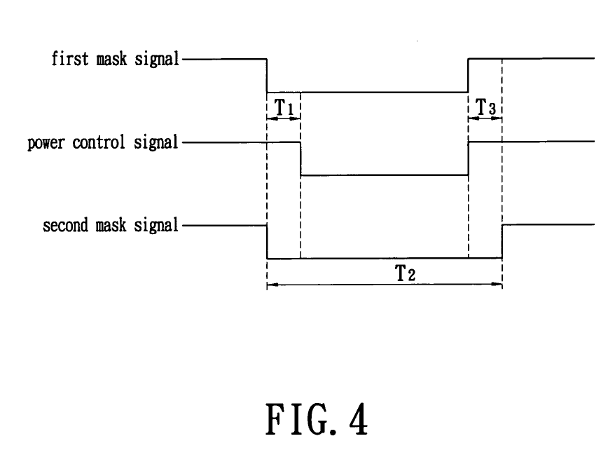

FIG. 4 shows the timing waveform of the video display system according to the preferred embodiment of the present invention. The first mask signal is generated by the CRTC 31 and supplied to the power controller 37. The power control signal and the second mask signal are generated by the power controller 37, and supplied to the image signal generator 36 and the display, respectively, When the first mask signal is enabled (from high level to low level), the display is at the horizontal blank time or the vertical blank time. At this time, the power controller 37 generates the second mask signal. After a time T1, the power controller 37 generates a power control signal indicating power off (from high level to low level) to the image signal generator 36 to reduce the power consumption of the image signal generator 36. After the duration of the first mask signal is over (from lower level to high level), the power controller 37 generates a power control signal indicating power on (from low level to high level) to the image signal generator 36 to restore the power supplied to the image signal generator 36. The second mask signal has a duration T2 in compliance with the regulation of Video Electronics Standards Association. The time T1 is shorter than one-character display time. The enabling time of the second mask signal is longer than the enabling time of the first mask signal and with difference T3 therebetween. The time T3 is shorter than the two-character display time and longer than the one-character display time. During the above limitations of T1 and T3, the video display system according to the preferred embodiment of the present invention has reduced power consumption while the video signal is normally displayed.

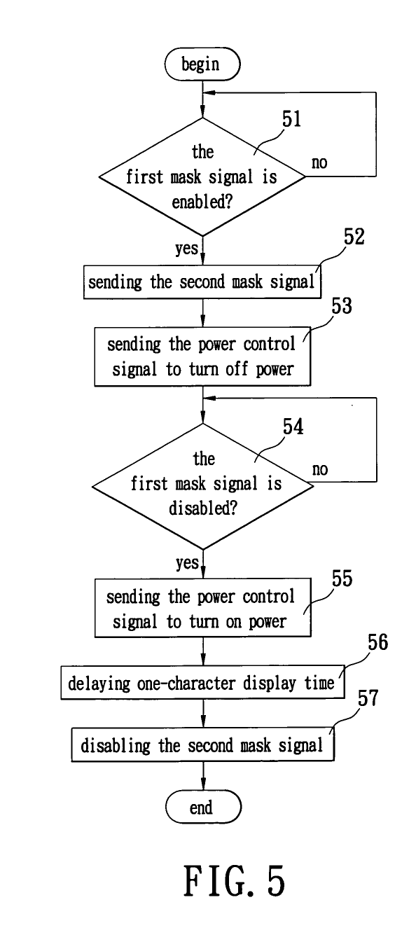

FIG. 5 shows a flowchart of the method for power conservation of video display system according to the preferred embodiment of the present invention. In this method, the power controller 37 will generate a power control signal to turn off or slow down the image signal generator 36 during the horizontal blank time or the vertical blank time. The step 51 judges whether the first mask signal is enabled, that is, whether the first mask signal is changed to low level from high level as shown in FIG. 4. If yes, step 52 simultaneously sends a second mask signal and then step 53 sends a power control signal indicating power off (from high level to low level) to the image signal generator. Step 54 judges whether the first mask signal is disabled, that is, whether the first mask signal is changed to high level from low level as shown in FIG. 4. If yes, step 55 sends a power control signal indicating power on (from low level to high level) to the image signal generator 36. The step 57 disables the second mask signal after a delay time of one-character display time. The method generates a power control signal to turn off the image signal generator 36 during the horizontal blank time or the vertical blank time for power conservation. The method also can generate a power control signal to slow down the image signal generator 36 during the horizontal blank time or the vertical blank time. However, the power saving effect is not optimal.

Hereinafter, three cases are provided as examples to demonstrate the operation of the present invention. The video display system of the present invention will turn off the image signal generator 36 during the horizontal blank time or the vertical blank time for power conservation, and then restore the power of the image signal generator 36 after the horizontal blank time or the vertical blank time. Moreover, the video display system of the present invention can be scanned in an interlaced way or non-interlaced way.

1. For a display with a resolution of 640×480, vertical refresh rate 60 Hz, horizontal blank time 5.72 μs, and vertical blank time 0.922 ms: the total blank time for a screen is 480×5.72, s+0.922 ms=3.668 ms. The scan time for a screen is 1/60=16.67 ms. The total blank time has a ratio of 3.668/16.67=21.96% for the scan time. The video display system of the present invention will have a 21.96% reduction in power consumption.

2. For a display with a resolution 1024×768, vertical refresh rate 60 Hz, horizontal blank time 4.923, s, vertical blank time 0.786 ms: the total blank time for a screen is 768×4.923 g s+0.786 ms=4.56 ms. The scan time for a screen is 1/60=16.67 ms. The total blank time has a ratio 4.56/16.67=27.56% for the scan time. The video display system of the present invention will have a 27.56% reduction in power consumption.

3. For a display with a resolution of 1600×1200, vertical refresh rate 85 Hz, horizontal blank time 2.44 μs, vertical blank time 0.471 ms. The total blank time for a screen is 1600×2.44 μs+0.471 ms=3.399 ms. The scan time for a screen is 1/85=11.8 ms. The total blank time has a ratio 3.399/11.8=28.8% for the scan time. The video display system of the present invention will have a 28.8% reduction in power consumption.

To sum up, the video display system and method for power conservation thereof, according to the present invention have following advantages:

1. Enhanced power saving effect: power is conserved during the horizontal blank time and the vertical blank time, even when the video display system is not idle.

2. Ensuring normal operation of the video display system: the image signal generator does not provide an image signal during the horizontal blank time and the vertical blank time, thus ensuring normal operation of the video display system.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A video display system used to display an image signal on a display unit, comprising:
a CRT controller (CRTC) for generating a synchronous timing signal for the display unit and a first mask signal;
an image signal generator for converting the image signal into a video signal with reference to the synchronous timing signal; and
a power controller controlling a power supplied to the image signal generator with reference to the first mask signal.

2. The video display system as in claim 1, wherein the image signal generator is a digital-to-analog converter (DAC).

3. The video display system as in claim 2, wherein the image signal generator further includes a look up table. (LUT), a multiplexer, and a gamma controller.

4. The video display system as in claim 1, wherein the image signal generator is a dither.

5. The video display system as in claim 4, wherein the image signal generator further includes a look up table (LUT), a multiplexer, and a gamma controller.

6. The video display system as in claim 1, wherein the power controller turns off a power supplied to the image signal generator during an enabling time of the first mask signal, and restores the power supplied to the image signal generator during a disabling time of the first mask signal.

7. The video display system as in claim 1, wherein the power controller further supplies a second mask signal to the display unit.

8. A method for power conservation of a video display system, wherein the video display system displays an image signal on a display unit, the method comprising following steps:
providing a first mask signal; and
executing a power conservation operation on the video display system during an enabling time of the first mask signal.

9. The method as in claim 8, wherein the enabling time of the first mask signal includes a time for a scan from a rightmost pixel to a leftmost pixel in a next horizontal line on a screen of the display unit.

10. The method as in claim 8, wherein the enabling time of the first mask signal includes a time for a scan from a rightmost pixel of a bottom horizontal line to a leftmost pixel in a top horizontal line on a screen of the display unit.

11. The method as in claim 8, wherein the step of power conservation operation includes turning off at least one circuit in the video display system and slowing down at least one circuit in the video display system.

12. The method as in claim 8, further comprising a step of speeding up or restoring power supplied to the video display system when the enabling time of the first mask signal is over.

13. The method as in claim 11, wherein the at least one circuit in the video display system includes a digital-to-analog converter (DAC).

14. The method as in claim 11, wherein the at least one circuit in the video display system includes a dither.

15. The method as in claim 11, wherein the at least one circuit in the video display system includes a gamma controller.

16. The method as in claim 11, wherein the at least one circuit in the video display system includes a multiplexer.

17. The method as in claim 11, wherein the at least one circuit in the video display system includes a look up table (LUT).

18. The method as in claim 8, further comprising a step of supplying a second mask signal to the display unit, wherein the second mask signal complies with regulations of Video Electronics Standards Association.

19. The method as in claim 8, wherein the video display system scans the display unit in an interlaced way.

20. The method as in claim 8, wherein the video display system scans the display unit in a non-interlaced way.
